(19) United States
(12) Patent Application Publication
(10) Pub. No.: US 2017/0320409 A1
(43) Pub. Date: Nov. 9, 2017

(54) CUSHIONED BUCKLE GUARD FOR CHILD'S CAR SEAT

(71) Applicants: Ashli Yvonne Babcock, Accokeek, MD (US); Sean Matthew Babcock, Accokeek, MD (US)

(72) Inventors: Ashli Yvonne Babcock, Accokeek, MD (US); Sean Matthew Babcock, Accokeek, MD (US)

(21) Appl. No.: 15/145,893

(22) Filed: May 4, 2016

(51) Int. Cl. B60N 2/28

(52) U.S. Cl. CPC B60N 2/2812; B60N 2002/2815

(57) ABSTRACT

A cushioned buckle guard consisting of a three-layer flaccid pad for placement in the chest region of a child restrained in a car seat. An outer heat-resistant layer is stitched to an internal padding layer and a subsequent flame-retardant inner liner. The car seat harness straps are slidably affixed to the harness retaining clip by straps on an outside major surface thereof. The pad is adapted to absorb and/or and redistribute the pressure from at least the harness retaining clip on the child so as to provide comfort to the restrained child.

### FIELD OF THE INVENTION

The invention pertains to protective devices for children's car seats and, more particularly, to a chest pad for placement between the harness clip of the children's car seat and the child in the car seat.

### BACKGROUND OF THE INVENTION

Young children are required by state and federal laws to be in a protective cars seat when traveling in a motor vehicle, at least until a certain age, weight, or height. Suitable car seats typically use the motor vehicle's seat belt(s) to fasten the car seat to the motor vehicle's seat. In some designs, the actual motor vehicle's seat belt surrounds the child and the buckle for that seat belt may end up in contact with the child in the car seat. In other child car seat designs, secondary straps and/or buckles associated with the child car seat itself end up in contact with the front of the child's body.

Such contact between a buckle and the child may during normal wearing become uncomfortable as a child wiggles, squirms, or otherwise moves or attempts to move while secured in the car seat. However, the bigger problem occurs when the motor vehicle must make a sudden stop. During a sudden deceleration (e.g., a “panic” stop), the inertia of the child and the child's car seat keep the car seat and its child passenger trying to move forward. When this happens, the strap and particularly any buckle touching the child may exert a large force on the child's chest or other frontal region. Depending on the amount of clothing the child may be wearing (i.e., a thick winter coat, a lightweight shirt, etc.), injury, possibly serious, may be inflicted on the child.

It would, therefore, be advantageous to provide an energy-absorbing pad between any strap or buckle and the child in the car seat.

### DISCUSSION OF THE RELATED ART

Several attempts to provide such protective may be found in the prior art. For example, U.S. Pat. No. 3,195,953 for ADJUSTABLE HEADREST issued Jul. 20, 1965 to Florence B. Zacks provides a headrest including a cushion with straps, the latter for holding straps. Alternatively, slots may be provided for retaining one of the straps.

U.S. Pat. No. 5,319,806 for SHOULDER GUARD HARNESS issued Jun. 14, 1994 to Jeffrey A. Hermann discloses a shoulder protector guard harness having an appearance as suspenders with attached shoulder pads to protect each shoulder of a wearer from bruises, lacerations and other injuries caused by heavy construction materials. Each pad is held in place by a vertical suspender strap at its front and back. The vertical straps attach to the wearer's belt or pants with clamps to hold the shoulder protector in place. A horizontal center strap attached to each vertical strap holds each vertical strap in place thereby assisting the secure placement of the shoulder pads on the shoulders of the wearer. The center strap includes an unpadded buckle disposed near the center of the wearer's chest.

U.S. Pat. No. 5,617,617 for FABRIC COVER FOR A SEATBELT BUCKLE issued Apr. 8, 1997 to Tom E. Gustin provides a supplemental seatbelt buckle cover system. The seatbelt buckle cover of the present invention is adapted to be removably positioned over a seatbelt buckle to protect a user from such a seatbelt buckle which may have inadvertently heated while in an automobile. In its broadest context, the cover includes a upper open end, a lower open end, a first open side and a second open side, as well as a slot positioned along the rearward wall of the cover. The slot allows the cover to be positioned over the shoulder belt of a seatbelt or, in the alternative, the lap belt of a seatbelt, rotated 90 degrees and slid onto the seatbelt buckle. Two springs are positioned within the opened first and second sides of the cover to allow the cover to be resiliently positioned and securely maintained upon the seatbelt buckle.

U.S. Pat. No. 7,293,828 for CHILD SEAT WITH DEPLOYABLE SIDE AIRBAGS issued Nov. 13, 2007 to Ryoichi Yoshida teaches a child seat that includes a seat body having a seat portion, a rear portion, and left and right side panels; airbags to be inflated at sides of a head of a child; and hollow cushions disposed along inner surfaces of the side panels. When an automobile equipped with the child seat collides, the airbags are inflated at the sides of the head of the child, so that an impact applied to the head is absorbed. Furthermore, the cushions absorb a large impact from sides in a side collision and the like. The cushions are preferably disposed below regions where the airbags are inflated. The cushions receive a part of the child other than the head to absorb the impact.

United States Published Patent Application No. 2011/0254344 FOR WHEELCHAIR SEAT BELT COVER DEVICE published Oct. 20, 2011 upon application by Cheryl Freeman, et al. shows a padded segment device for wheelchair restraint belts that functions to decrease chaffing, rash or other injury related to long-term wear. The device functions by wrapping a padded segment around restraint belts at critical contact points. Additionally′ a system employing multiple padded segment devices used in conjunction with an open padded segment allows the practitioner to customize the device to any type of wheelchair design, including protection from and access to a restraint buckle.

United States Published Patent Application No. 2011/0283446 LIFE VEST published Nov. 24, 2011 upon application by Robert James Baldauf, et al. shows a vest having front and rear members made of rigid or semi-rigid material where each member has recesses for receiving a user's head and both arms. Left and right shoulder pads are located between and attached to both members on each side of the recess for receiving the user's head with pivotally connecting members, and side access panels are located between and removably attached to both members below the left and right recesses for a user's arms with pivotally connecting members which prevent the shoulder pads and the side access panels from being displaced laterally from the front and rear members when the vest is subjected to a compression load. A lift harness is integrated into the front and rear members and a lift ring, which is permanently connected to the lift harness, is removably connected to a rescue rope that has distance markings thereon.

U.S. Pat. No. 8,739,739 for APPARATUS FOR SUPPORTING AN ANIMAL WITH A SEATBELT issued Jun. 3, 2014 to Robert L. Davis teaches an animal or pet restraint apparatus for supporting an animal in a vehicle. The animal restraint apparatus adapted to engage with a vehicle seatbelt assembly having a waist strap portion and a shoulder strap portion. The apparatus is comprised of a flat tubular body having a tubular passage configured for releasably receiving the seatbelt assembly and a means for releasably engaging the back panel portion of the flat tubular body to the lower chest portion of a pet, avoiding the neck area. The present invention and its embodiments provide a means for safely and comfortably transporting a pet in a vehicle.

United States Published Patent Application No. 2014/0159350 for BELT INTEGRATED AIRBAG published Jun. 12, 2014 upon application by AUTOLIV DEVELOPMENT, AB provides a restraint system for a seat that may include a first portion having a first end fixed for movement with the seat and a second end movable relative to the seat. The restraint system may also include a second portion having a first end fixed for movement with the seat and a second end movable relative to the seat and selectively attached to the second end of the first portion. An inflator may be associated with the second portion and may move the second portion from a pre-deployed state to an inflated state. The inflator may be at least partially disposed within the second portion.

None of the patents nor published patent applications, taken singly, or in any combination are seen to teach or suggest the Cushioned Buckle Guard for Child's Car Seat of the present invention.

### SUMMARY OF THE INVENTION

In accordance with the present invention there is provided a cushioned buckle guard consisting of a three-layer flaccid pad for placement in the chest region of a child restrained in a car seat. An outer heat-resistant layer is stitched to an internal padding layer and a subsequent flame-retardant inner liner. The harness straps are slidably affixed to the cushioned buckle guard by straps on an outside major surface thereof. The pad is adapted to absorb and/or redistribute the pressure of the buckle and/or harness straps on the chest of the child so as to proved comfort to the restrained child.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a top plan view of the cushioned buckle guard in accordance with the invention; and

FIG. 2 is a side elevational, cross-sectional, schematic view of the cushioned buckle guard of FIG. 1.

### DETAILED DESCRIPTION OF THE PREFERRED EMBODIMENT

The present invention provides a cushioned buckle guard for placement between the chest region of a child restrained in a car seat and the car seat harness retaining clip and/or harness straps. The harness straps are slidably affixed to the cushioned buckle guard by straps on an outside major surface thereof. The cushioned buckle guard is adapted to absorb and/or redistribute the pressure of the harness retaining clip and/or harness straps on the child so as to provide comfort to the restrained child.

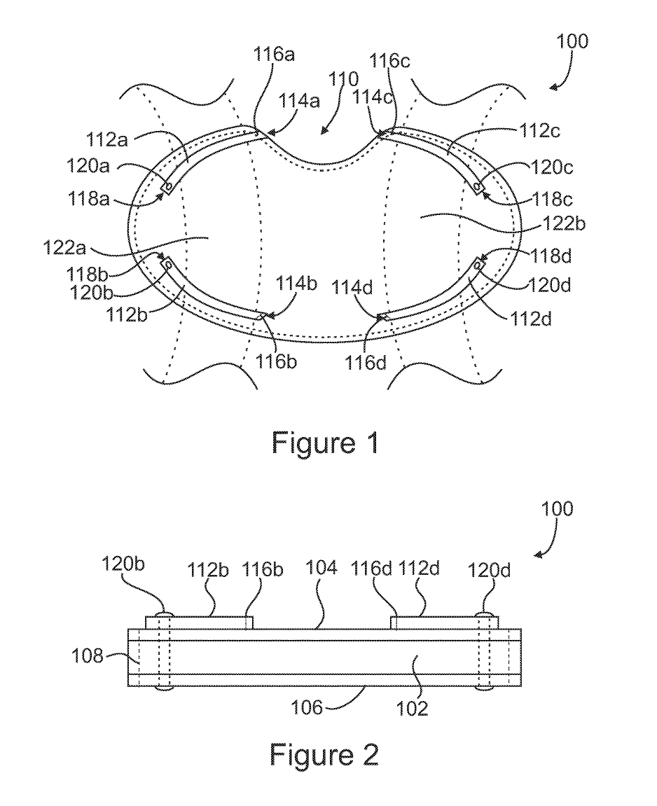

Referring to FIGS. 1 and 2, there are shown top plan and side elevational, cross-sectional schematic views, respectively, of a cushioned buckle guard (CBG) in accordance with the invention, generally at reference number 100.

CBG 100 typically comprises three layers. A substantially oval-shaped internal layer 102 typically comprises 100% hypoallergenic 100% polyester fiber. A particular material found suitable for the application is NuFoam™ supplied by Fairfield Processing of Danbury, Conn. USA. Internal layer 102 is typically approximately 0.5 inches in thickness. It will be recognized that alternate suitable materials known to those of skill in the art may be substituted for the NuFoam™ material chosen for purposes of disclosure. Also, thicknesses other than 0.5 inches may be chosen to meet a particular operating circumstance or environment. Consequently, the invention is not considered limited to either the NuFoam™ material or the 0.5 inch thickness. Rather, the invention is intended to include any and all suitable substitute materials and/or thicknesses.

An “inner” liner layer 106 (i.e., the layer facing the restrained child, not shown and forming not part of the invention), typically comprises a ROC-Ion® 100% cotton flame resistant fabric provided by Rockland Industries, Inc. with facilities in Baltimore, Md. and Bamberg, S.C., USA. Inner layer 106 is substantially the same shape and size as internal layer 102.

An “outer” layer 104 (i.e., the layer facing outwardly away from the restrained child) completes the sandwich. Inner layer 104 is formed from a heat resistant fabric. A product found suitable for the application is Therma-Flec heat resistant cotton fabric provided by James Thompson & Co. Inc. headquartered in New York, N.Y. USA. The Therma-Flec fabric is typically provided with a silver colored outer surface. It will be recognized by those of skill in the art that suitable alternate heat-resistant fabrics may be available and substituted for the fabric chosen for purposes of disclosure. Consequently, the invention is not considered limited to the Therma-Flec fabric but is intended to include any and all suitable substitute fabrics. Outer layer 104 is also substantially the same shape and size as internal layer 102.

Outer layer 104, internal layer 102, and inner layer 106 are typically stitched together around their respective perimeters, not specifically identified, with stitching 108. Stitching 108 comprises a suitable flame resistant and/or a fire retardant thread. Suitable threads are believed to be well known to those of skill in the art and, consequently are neither further described or discussed herein.

A semi-circular notch 110 is disposed in the center of the upper edge, not specifically identified, of CBG 100 to accommodate the neck, not specifically identified, of the restrained child.

Four detachable straps 112a, 112b, 112c, 112d are disposed on the outer surface, not specifically identified, of outer layer 104 of CBG 100. Detachable straps 112a, 112b, 112c, 112d typically comprise fabric similar to the outer layer 104. Detachable straps 112a, 112b, 112c, 112d have a respective distal end 114a, 114b, 114c, 114d permanently affixed to CBG 100, typically by stitching 116a, 116b, 116c, 116d.

Respective proximal ends 118a, 118b, 118c, 118d of straps 112a, 112b, 112c, 112d are equipped with a recloseable fastener such as a snap 120a, 120b, 120c, 120d. It will be recognized by those of skill in the art that a wide variety of other recloseable fastener types may be substituted for snaps. Consequently, any suitable recloseable fastener may be used and the invention is not considered limited to the recloseable fastener used for purposes of disclosure.

Recloseable fasteners 120a, 120b, 120c, 120d may be opened thereby making it possible for straps 122a, 122b to be passed over the outer surface of CBG 100 and then straps 122a, 122b to be retained by 112a, 112b, 112c, 112d when recloseable fasteners 120a, 120b, 120c, 120d are subsequently re-closed.

Straps 122a, 122b are typically either a portion of a vehicle seat belt system or more typically, harness straps of a child restraint seat. In either case, straps 122a, 122b form no part of the present invention and are shown to illustrate CBG 100 in its intended operating environment.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. A cushioned buckle guard for a child safety car seat, comprising:
a) a substantially oval central padding layer having a shape and a perimeter;
b) a front, outer covering fabric layer having a shape and perimeter identical to said shape and perimeter of said oval central padding layer;
c) a rear, inner covering fabric layer also having a shape and and perimeter also identical to said shape and perimeter of said oval central padding layer;
d) stitching disposed adjacent said perimeters of said front, outer covering layer, said substantially oval central padding layer, and said rear inner fabric layer, said stitching joining each of said front, outer covering layer, said substantially oval central padding layer, and said rear inner fabric layer one to another;
e) a semi-circular notch centrally disposed said perimeters to accommodate a neck of a child retained in said child safety car seat;
f) at least two straps disposed on said front outer covering layer, each strap having a distal end fastened to said stitched front, outer covering layer, said substantially oval central padding layer, and said rear inner fabric layer; and
g) a recloseable fastening device affixed proximate a proximal end of each of said at least two straps.

2. The cushioned buckle guard for a child safety car seat as recited in claim 1, wherein said substantially oval central padding layer comprises 100% hypoallergenic 100% polyester fiber.

3. The cushioned buckle guard for a child safety car seat as recited in claim 2, wherein said substantially oval central padding layer has a thickness of approximately 0.5 inch.

4. The cushioned buckle guard for a child safety car seat as recited in claim 1, wherein said front, outer covering fabric layer comprises a 100% cotton flame resistant fabric.

5. The cushioned buckle guard for a child safety car seat as recited in claim 1, wherein said rear, inner covering fabric layer comprises a cotton heat resistant fabric.

6. The cushioned buckle guard for a child safety car seat as recited in claim 5, wherein said cotton heat resistant fabric comprises a silver colored outer surface.

7. The cushioned buckle guard for a child safety car seat as recited in claim 1, wherein said perimeter stitching comprise thread having at least one characteristic chosen from the group: heat resistant, and flame retardant.
